(19) United States
(12) Patent Application Publication
(10) Pub. No.: US 2015/0238789 A1
(43) Pub. Date: Aug. 27, 2015

(54) ROOF TOP SPRINKLER SYSTEM

(71) Applicants: Harold Johnson, Union City, CA (US); Dwayne L. Bracy, Tracey, CA (US)

(72) Inventors: Harold Johnson, Union City, CA (US); Dwayne L. Bracy, Tracey, CA (US)

(21) Appl. No.: 14/624,351

(22) Filed: Feb. 17, 2015

Related U.S. Application Data
(60) Provisional application No. 61/941,429, filed on Feb. 18, 2014.

(51) Int. Cl. A62C 3/02; A62C 35/68

(52) U.S. Cl. CPC A62C 3/0214; A62C 35/68

(57) ABSTRACT

A system of fire protective sprinklers that fully cover and wet all areas of a structural roof threatened by a rapidly spreading fire, comprising a strategically placed array of roof mounted, long range water sprinkler heads, capable of fully covering the surface of the roof with a continual spray, keeping the roof wet to reduce its susceptibility to airborne embers that otherwise might ignite a fire; piping to carry water to the sprinkler heads; and a water source to provide water.

### CLAIM OF PRIORITY

This patent application claims priority under 35 USC 119 (e) (1) from U.S. Provisional Patent Application Ser. No. 61/941,429 filed Feb. 18, 2014, of common inventorship herewith entitled, “Roof Top Sprinkler System,” which is incorporated herein by reference as though the same were set forth in its entirety.

### FIELD OF THE INVENTION

The present invention pertains to the field of fire protection, and more specifically to the field of fire sprinkler systems.

### BACKGROUND OF THE INVENTION

The prior art has put forth several designs for fire sprinkler systems. Among these are:

US Patent 2011/0247842 to Hayden Huber describes a wildfire protection system that has at least one rotating sprinkler having a base mounted atop a ridge of a structure or dwelling roof. The rotating sprinkler is coupled to one end of a typical garden hose having an opposite end coupled to a hose bib for providing water thereto. The base of the rotating sprinkler includes a metallic or fire proof material and includes mounting holes for fastening the sprinkler to the roof. When deployed, the sprinkler wets the rooftop and nearby flammable materials to prevent the structure or dwelling from being set on fire by flying embers and the like.

U.S. Pat. No. 7,673,696 to Tim Gunn describes a sprinkler system that is quickly deployed to prevent brush and forest fires from engulfing a home. The system includes at least one assembly with a sprinkler on a base. The base straddles the roof ridge. The base adjusts to different roof pitches. The assemblies include hose interfaces to allow connection of a hose routed from a water supply. A fire retardant solution or fire fighting foam is added downstream of the supply. The sprinklers wet the rooftop and a portion of the surrounding grounds. An optional pump and independent power supply are added to route water from an available reservoir.

US Patent 2008/0289830 to Eric Olson describes a roof top fire prevention sprinkler system, with or without an optional and separate storage rack, that is comprised of a rotating sprinkler head mounted on a support frame of conduit having fluid communication between a water source and the sprinkler head. The frame, having a more or less rectangular shape bent in the middle of the long sides, saddles the peak of a roof to be protected. At the bend in the frame, at the roof peak, a cross piece of conduit bisects the long sides of the rectangle and is in fluid communication therewith. The sprinkler head is connected to the middle of the cross piece. Water is suppliable through a garden hose connected to a pipe extension of stiff conduit which in turn is connected to one of the short sides of the rectangle. The pipe extension also acts as a pole to place or retrieve the support frame at or from the roof peak without the user having to climb onto the roof. Cylindrical pliant rollers surrounding the short sides of the rectangle allow the frame to glide easily up a sloping side of a pitched roof. The optional storage rack holds the sprinkler and frame, disconnected from the pipe extension, on end against a wall, taking up little space when not in use.

None of these prior art references describe the present invention.

### SUMMARY OF THE INVENTION

It is an object of the present invention to provide a system of fire protective sprinklers that fully cover and wet all areas of a structural roof threatened by a rapidly spreading fire such as a forest fire.

### BRIEF DESCRIPTION OF THE DRAWINGS

FIG. 1 is an illustrative prototypical diagonal front view showing a residence with internally installed piping and long range sprinkler heads spaced evenly around the roof line.

FIG. 2 is an illustrative prototypical diagonal front view showing a residence with under gutter installed piping and long range sprinkler heads spaced evenly around the roof line.

FIG. 3 is a prototypical close up diagonal view showing roof top sprinklers that are plumbed into the lawn sprinkler system.

FIG. 4 is a prototypical close up diagonal view showing roof top sprinklers that are plumbed into the structure's existing outside faucet.

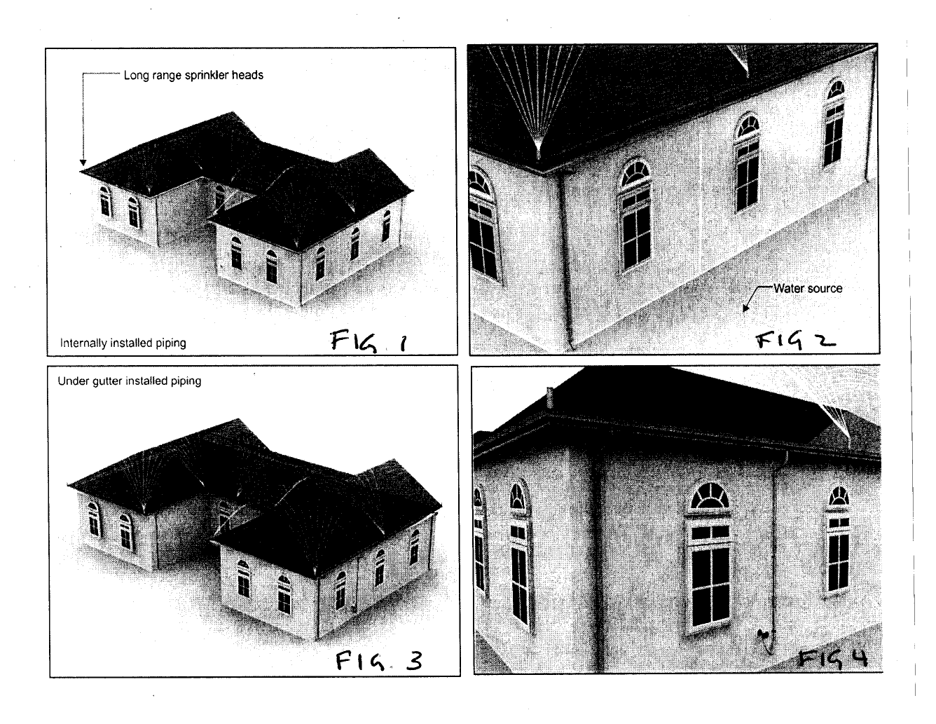

### DETAILED DESCRIPTION OF THE INVENTION

House fires occur frequently and cause devastating losses, injuries and deaths. Perhaps the most terrifying aspect of a house fire is the rapidity with which it spreads. One minute, one has a grease fire on a stove, and in the next minute, one's entire kitchen is in flames. When a house fire gets going, any individual in the house becomes blinded by thick and toxic smoke which one has to breathe when attempting escape. A house fire literally deprives its victims of their senses and in doing so, eventually kills them. Those victims who are fortunate enough to survive a fire often face emotional and financial trauma. Their homes and possessions are all burnt away and in the worst cases, one or more loved ones lost.

The statistics are sobering. The stories are tragic. There are few things more horrifying than a house fire and yet, they happen all the time. And for those people who live in regions that are tinder dry on a seasonal basis, the threat is compounded. In these regions, wildfires take hold and spread rapidly, all too often becoming fire storms that burn entire neighborhoods. Forest fires cause billions of dollars in damage and claim the lives of people caught in their path every year. Embers the size of softballs rise from the flames and drop like hand grenades on house roofs. When a roof is dry, it too erupts. An entirely unaffected house becomes a flaming ruin in less than five minutes. One burning house turns into two, then four and so on, until an entire neighborhood is one hellish inferno. Knowing this, homeowners often stay behind, risking their lives to protect their homes by dampening their roofs with water from a garden hose which is sometimes an effective measure, as long as owners can stay. Once they are ordered to evacuate, the roof dries out and a fire claims another home.

The present invention, hereinafter referred to as the Roof Top Sprinkler System, is a system of fire protective sprinklers which function to fully cover and wet all areas of a roof in the event the structure is threatened by a spreading fire. The Roof Top Sprinkler System keeps the roof wet and permits an owner to flee to safety. The Roof Top Sprinkler System equips a house or other structure with a strategically placed array of roof mounted, water sprinkler heads. When activated, the sprinklers fully cover the surface of the roof with a continual spray, keeping the roof wet to reduce its susceptibility to airborne embers that otherwise might ignite a fire. The Roof Top Sprinkler System is an individually customizable system, adaptable to any roof and comprised of a number of individual sprinkler heads that depend on size, style and layout of the roof to be equipped. Depending on the size, height, and layout of the structure and roof, the Roof Top Sprinkler System is plumbable into a structure's existing plumbing system or potentially into its lawn sprinkler system, or outside faucet. In cases where no city water is available or the city water utility or the structure's well and pump system are inadequate to the pressure demands of the system, a separate auxiliary pump is required, and possibly an auxiliary water supply.

Piping for the Roof Top Sprinkler System can be internally installed into the soffit of a building. Alternatively, the piping can be externally installed under the gutters.

A building owner can turn the system on in the event a fire threatens and then leave it on. If necessary, an owner can leave the premises for his or her own safety. The Roof Top Sprinkler System switch is wireable to tie in with a building's smoke detectors, activating automatically in response to the smoke detectors' activation. Using the Roof Top Sprinkler System, a homeowner has a peace of mind that comes with knowing all has been done in terms of preparing for a fire hazard and in terms of fighting it.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A system of fire protective sprinklers that fully cover and wet all areas of a structural roof threatened by a rapidly spreading fire, comprising:
a strategically placed array of roof mounted, long range water sprinkler heads, capable of fully covering the surface of the roof with a continual spray, keeping the roof wet to reduce its susceptibility to airborne embers that otherwise might ignite a fire;
piping to carry water to the sprinkler heads; and
a water source to provide water.

2. The system of fire protective sprinklers of claim 1, further comprising:
an individually customizable system, adaptable to any roof and comprised of a number of individual sprinkler heads that depend on size, style and layout of the roof to be equipped.

3. The system of fire protective sprinklers of claim 1, wherein the system is plumbable into a structure's existing plumbing system, or outside faucet.

4. The system of fire protective sprinklers of claim 1, wherein the system is plumbable into a structure's lawn sprinkler system.

5. The system of fire protective sprinklers of claim 1, further comprising a separate auxiliary pump in cases where no city water is available or the city water utility or the structure's well and pump system are inadequate to the pressure demands of the system.

6. The system of fire protective sprinklers of claim 1, further comprising an eternal water supply.

7. The system of fire protective sprinklers of claim 1, wherein the system is capable of receiving a signal from a structure's smoke detectors, activating the sprinkler system automatically in response to the smoke detectors' activation.

8. The system of fire protective sprinklers of claim 1, wherein piping is externally installed under gutters.

9. The system of fire protective sprinklers of claim 1, wherein piping is internally installed into the soffit of a building.
